(19) United States
(12) Patent Application Publication
(10) Pub. No.: US 2012/0037262 A1
(43) Pub. Date: Feb. 16, 2012

(54) RETRACTABLE ENERGY ABSORBING WEBBING AND METHOD OF MANUFACTURING SAME

(75) Inventor: Timothy M. Russell, Anniston, AL (US)

(73) Assignee: YKK Corporation of America, Marietta, GA (US)

(21) Appl. No.: 12/855,341

(22) Filed: Aug. 12, 2010

(51) Int. Cl. D03D 1/00; D03D 41/00; F27D 3/00

(52) U.S. Cl. 139/383 R; 432/11; 139/11

(57) ABSTRACT

Energy absorbing webbings that are generally flat and that have a controllable elongation distance are provided. The webbings are comprised of elongation yarns, such as partially oriented yarns (POY), and ground yarns. In certain embodiments, because they are generally flat, the energy absorbing webbings are suitable for use in retractors. Also provided are processes of manufacturing generally flat, energy absorbing webbings. In certain embodiments, the webbings are subjected to heat using first and second set of rollers with various feed ratios.

### BACKGROUND OF THE INVENTION

People at elevated positions above a floor or other relatively lower surface are at risk of falling and injury. For example, workers and other personnel who have occupations that require them to be at elevated positions, such as on scaffolding, are at risk of falling and injury. Safety harnesses are often worn to stop a person's fall and prevent or reduce injury.

Safety harnesses typically have a harness portion worn by the user and a tether or lanyard extending from the harness portion. The lanyard connects the harness portion to a secure structure. If a person falls from the elevated position the safety harness stops the person's fall when the lanyard is straightened.

A load limiter on a seat belt system can be worn to secure the occupant of a vehicle in the event of a sudden stop or collision to reduce the risk of injury. If a person is subjected to inertia due to a vehicle's sudden stop, the load limiter limits the person's forward movement when the load limiter is straightened.

Retractable lanyard devices are used in some fall protection applications, and retractable load limiter devices are used in some seat belt systems. Retractable lanyard devices are typically comprised of a flat webbing that is capable of being received within a retractor. Existing retractable lanyard devices have a mechanical device in the retractor to stop the fall (by preventing the webbing from advancing further out of the webbing) or to dissipate energy (by deforming metal). With typical retractable lanyards devices, however, the person's movement is stopped rather abruptly and the person is subjected to the shock force of the abrupt stop. Moreover, existing retractable lanyard devices are bulky, heavy, and costly.

Lanyards that attempt to absorb the shock of a person's fall are known. Such lanyards, however, have bunched, accordion-type sections that lengthen as energy is absorbed. These bunched sections prevent the use of an energy absorbing webbing in a retractor, since a retractor requires the use of a flat webbing. Thus, a need exists for a retractable lanyard that absorbs energy.

### SUMMARY OF THE INVENTION

Certain embodiments of the invention generally pertain to energy absorbing webbings and lanyards, and methods of making them. More specifically, some embodiments of the invention pertain to an energy absorbing webbing that is generally flat and therefore capable of being received within a retractor.

### BRIEF DESCRIPTION OF THE FIGURES

FIG. 1 is a perspective view of a retractor in use with an energy absorbing webbing according to one embodiment of the invention.

FIG. 2 is a side cross-sectional view of the energy absorbing webbing shown in FIG. 1.

FIG. 3 is a top cut-away view of the energy absorbing webbing of FIG. 1.

FIG. 4 is an illustration of a heating process for manufacturing the energy absorbing webbing of FIG. 1 according to one embodiment of the invention.

FIG. 5 is a pick diagram of a weaving pattern of the energy absorbing webbing of FIG. 1 according to one embodiment of the invention.

FIG. 6 is a draw-in diagram of the energy absorbing webbing of FIG. 1 according to one embodiment of the invention.

### DETAILED DESCRIPTION OF THE INVENTION

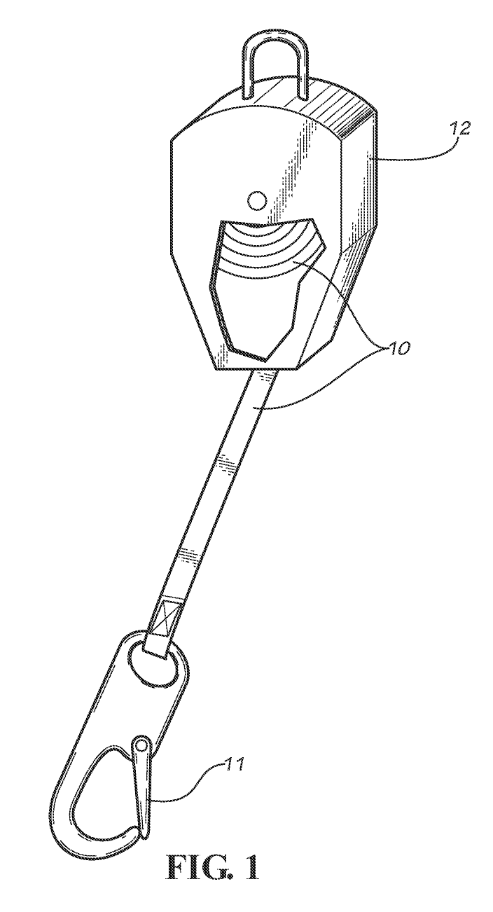

Certain embodiments of the invention provide webbings 10 that are suitable for use in retractors, such as retractor 12 shown in FIG. 1. As illustrated in FIG. 1, because webbing 10 is generally flat, webbing 10 is capable of being received within retractor 12 and of being retracted in and out of retractor 12.

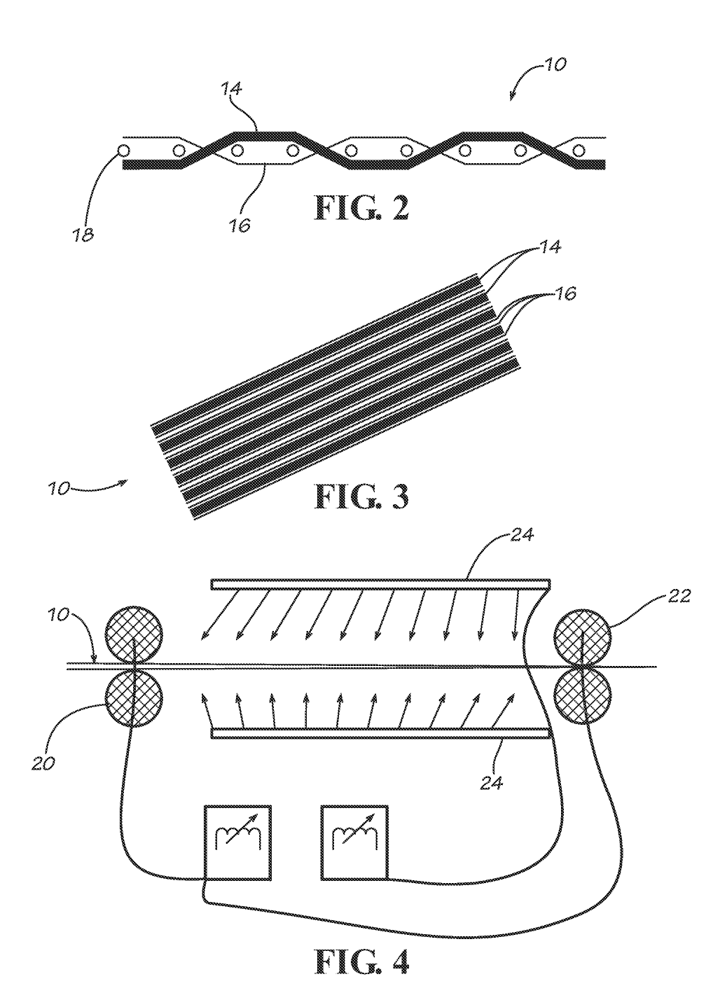

As shown in FIG. 2, webbing 10 comprises elongation yarns 14 and ground yarns 16 that are interwoven together. In some embodiments, ground yarns 16 are nylon, polyester, Kevlar, or any other high modulus, high tenacity yarn or other suitable materials that are relatively higher strength and that do not shrink or shrink substantially less than the elongation yarns 14 during heat treatment. For example, in some embodiments, the ground yarns 16 have a strength of at least 5,000 pounds tensile strength. In other embodiments, the ground yarns have a nominal breaking strength of greater than 5,400 pounds and, in some embodiments, have a nominal breaking strength exceeding 6,000 pounds, in compliance with 29 C.F.R. 1926.104(d) (2008), American National Standards Institute (“ANSI”) Z335.1, Canadian standard Z259.1.1 Class 1A and 1B, European standard BS EN 355:2002, and Australian standard AN/NZS 1891.1.1995.

Elongation yarns 14 are highly extensible yarns and significantly stretch when placed under a tensile load. The elongation yarns 14 are one example of an energy absorbing member of the webbing 10. In one embodiment, the elongation yarns 14 are partially oriented yarns (POY) made of polymer materials such as polyester, but the elongation yarns 14 can be made from one or more suitable materials having high elongation properties and the ability to shrink in length substantially more than the ground yarns, such as during heat treatment. In some embodiments, each of the elongation yarns has a linear density of between approximately 300 denier and approximately 5,580 denier.

The elongation yarns 14 have an elongation property that allows the elongation yarns 14 to stretch significantly under a predetermined tensile force. The elongation yarns 14 have this elongation property even after they are subjected to a heat treatment process. When the webbing 10 is placed under tensile load, the elongation yarns 14 stretch under tension and absorb some of the force or energy applied to the webbing 10. Accordingly, the elongation yarns 14 are a shock and energy absorbing member that provides a shock and energy absorbing feature.

In some embodiments, lateral yarns 18 (also referred to as “weft” or “pick” yarns) are woven in a weft direction across the webbing 10 to secure the elongation yarns 14 and the ground yarns 16 laterally across the webbing 10. In some embodiments, the lateral yarns 18 are approximately 1,000 denier polyester yarns. In other embodiments, the lateral yarns 18 are industrial filament polyester, nylon, Nomex, Kevlar, or any other suitable yarn.

Important properties of the elongation yarns 14, which serve as the energy absorbing member, include some or all of high elongation, high shrinkage, and high shrink-force (the force produced during the shrinkage). The elongation yarns 14 should have sufficiently high elongation and load bearing properties under load to absorb the load energy so as to reduce shock to a person or other body in a sudden deceleration state such as that caused by a fall from a building, a parachute deploying, or an impact due to an automobile or aircraft accident. In some embodiments, the webbings are adapted for use where dissipation of kinetic energy is required.

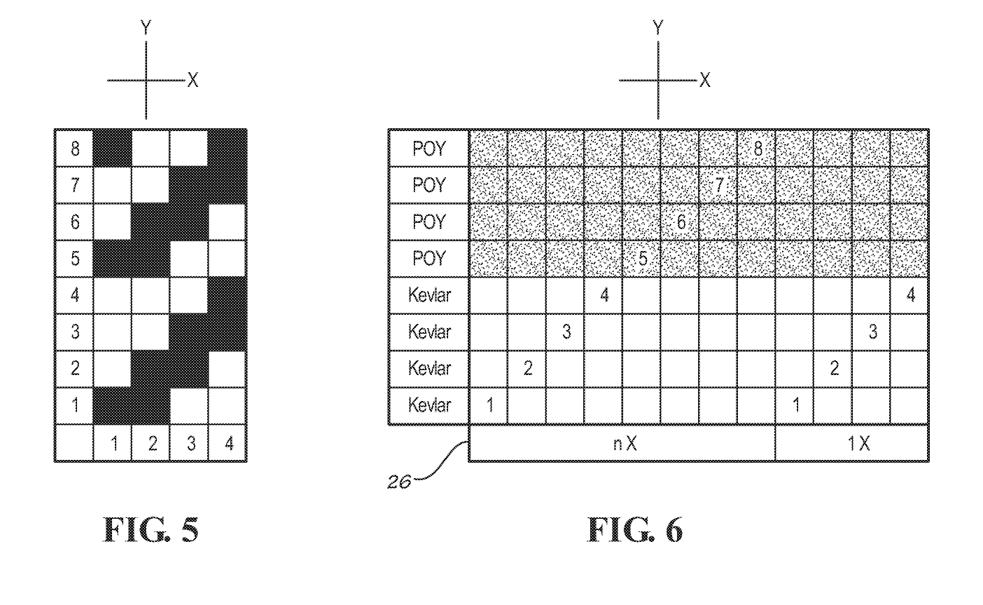

Webbings of the present invention may be foamed on any desired programmable loom, such as a needle loom. As described above, the webbing 10 includes elongation yarns 14, ground yarns 16, and lateral yarns 18. FIG. 5 is a pick diagram (also known as a chain diagram or cam draft) for the webbing 10. The squares along the x-axis represent the weaving path/throw of the lateral yarns 18, and the y-axis corresponds to groups of warp yarns (such as the elongation yarns 14 and the ground yarns 16). The pick diagram of FIG. 5 shows an eight harness loom. When a square is shaded, it indicates that the harness corresponding to that square is lifted as the lateral yarn 18 is thrown across the loom.

The draw-in diagram of FIG. 6 shows the placement of the elongation yarns 14 and the ground yarns 16 in harnesses to produce the webbing 10 of FIGS. 2-3, while the pick diagram of FIG. 5 represents the action of the harnesses with respect to the lateral yarns 18 to create the webbing 10. The y-axis of the draw-in diagram of FIG. 6 represents the number of harnesses of a loom used to make the webbing 10. In this embodiment, eight harnesses are used. In the embodiment shown in FIG. 6, the bottom four harnesses (harnesses 1-4) comprise the ground yarns 16 and the top four harnesses (harnesses 5-8) comprise the elongation yarns 14. The x-axis of FIG. 6 represents the yarns that are used to create the webbing 10, with row 26 showing the number of times each segment of the diagram repeats. For example, in one embodiment, the first segment can repeat any number of times (nX), while the second segment repeats one time (1×). The first column of FIG. 6 illustrates that the first yarn is in the first harness frame, and the second yarn is in the second harness frame. In one embodiment, the webbing may be formed on any narrow fabric loom, including shuttle looms.

In one embodiment, the webbing 10 is a 4 foot by 1 and ⅜ inch nylon structure formed from approximately 248 Kevlar ground yarns (the ground yarns having a linear density of approximately 1,500 denier) and 90 elongation yarns (the elongation yarns being partially oriented yarns with a linear density of approximately 5580 denier).

In some embodiments, one end of the webbing 10 is attached to a hardware component, such as a clip 11, metal clasp, harness, or seatbelt component, while the other end of the webbing 10 is situated within a retractor 12 (shown in FIG. 1) that is then secured to a stable structure. In some embodiments, one end of the webbing 10 is attached to a harness and/or a clip for attachment to a child seat for use, for example, in an automobile or other vehicle.

In some embodiments, the webbing 10 is used as a deceleration device, to secure the occupant of a vehicle against harmful movement that may result from a sudden stop, or in any other application where rapid human or other body deceleration may occur. When using the webbing as a fall protection device, one end of the webbing 10 is securely attached to a safety harness worn by a user. The opposite end of the webbing 10 is securely attached to a fixed structure. If the user falls, the webbing 10 stops the person's fall and reduces the shock felt by the person as the user is brought to a controlled deceleration. As the person falls, the webbing 10 straightens and the load of the user is applied to the webbing 10. The elongation yarns 14 stretch and absorb the force of the load applied to the webbing 10. As the elongation yarns 14 stretch, the webbing 10 elongates. In the embodiments where the webbing is used with a retractor, once the webbing 10 has retracted from the retractor 12, the webbing 10 stops the person from falling any farther. The shock of stopping the fall that would otherwise be felt by the falling person is reduced or cushioned by the energy-absorbing elongation yarns 14.

Also provided is a process of manufacturing a generally flat energy absorbing woven webbing, such as webbing 10. In one embodiment, webbing 10 is subjected to heat treatment to shrink the length of the elongation yarns 14. When the webbing 10 is subjected to heat treatment, the elongation yarns 14 shrink in length while the ground yarns 16 do not, resulting in a greater weave-in of the elongation yarns 14 than the weave-in of the ground yarns 16, where weave-in refers to the percentage difference in the length of the yarn before weaving and the length of the webbing after weaving. In some embodiments, the ground yarns 16 and the elongation yarns 14 both start with an about 6% weave-in, such that the length of the elongation yarns 14 and the ground yarns 16 are approximately 6% greater than the length of the webbing 10. In one embodiment, after the webbing 10 is subjected to heat treatment, the length of the elongation yarns 14 and the length of the webbing 10 shrink by approximately 20%, while the length of the ground yarns 16 does not shrink. Thus, in this embodiment, the elongation yarns 14 will remain at around 6% weave-in while the ground yarns will have around 26% weave-in. In this way, the relative lengths of the elongation yarns 14 and the ground yarns 16 are automatically adjusted upon heat treatment. In one embodiment, the webbing 10 is heat treated in a manner so that shrinkage of the elongation yarns 14 is controlled.

For example, as illustrated in FIG. 4, the webbing 10 may be subjected to a heat treating process to adjust the length of the yarns of the webbing 10. The heat treatment apparatus of FIG. 4 includes a first set of rollers 22, a second set of rollers 20, and a heat source 24 located between the first and second set of rollers. Optionally, the apparatus may also include controls and/or monitors to control and/or monitor the feed ratio between the two sets of rollers and/or the temperature of the heat source.

In one embodiment, the webbing 10 is fed through the first set of rollers 22 to the heat source 24, and out through the second set of rollers 20. As shown in FIG. 4, the thickness of the webbing 10 changes as the webbing 10 is drawn from the first set of rollers 22 toward the second set of rollers 20. This is because the weave-in of the ground yarns 16 increases as the webbing 10 is subjected to heat treatment. In certain embodiments, the amount of shrinkage of the elongation yarns 14 is controlled by varying the difference in speed of the first set of rollers 22 and the speed of the second set of rollers 20. This difference in speed is referred to herein as the feed ratio of the rollers.

In one embodiment, the speed at which the webbing 10 is fed through the first set of rollers 22 is greater than the speed at which the webbing 10 is fed through the second set of rollers 20. For example, in one embodiment, the feed speed associated with the first set of rollers 22 is approximately 10 yards per minute, while the feed speed associated with the second set of rollers 20 is approximately 8 yards per minute, for a feed ratio of 20%. Since the webbing 10 is exiting the heat source 24 at a speed that is 20% slower than the speed at which it entered the heat source 24, the webbing 10 is subjected to an over feed ratio of 20% during heat treatment by the heat source 24. In this way, the elongation yarns 14 will remain in tension between the first set of rollers and the second set of rollers and will be allowed to shrink approximately 20%, while the other materials (such as the ground yarns 16) are gathered by the forces of the elongation yarn shrinkage, which results in a greater than 20% weave-in and a length reduction of 20%. Because the elongation yarns 14 shrink when subjected to heat, while the ground yarns 16 do not have more than minimal shrinkage, the heat treatment process adjusts the relative length of the elongation yarns and the ground yarns. In some embodiments, the webbing 10 is subjected to approximately less than 5 minutes of heat treatment at a temperature of about 220° F.

The amount of elongation yarns 14 in the webbing 10 may be varied to adjust the forces required to elongate the webbing 10. Similarly the shrinkage of the elongation yarns 14 in the webbing 10 may be varied to adjust the elongated distance, or the relative difference in length between the elongation yarns 14 and the ground yarns 16 of the webbing 10. As described above, the difference in length between the two sets of yarns is caused by the difference in weave-in of the yarns. Similarly, the feed ratios between the first set of rollers 20 and the second set of rollers 22 may be varied to adjust the forces required to elongate the webbing 10 and the elongation distance of the webbing 10. Finally, the duration and amount of heat applied to the webbing 10 also may be varied to adjust the forces required to elongate the webbing 10 and the elongation distance of the webbing 10. This allows the properties of the webbing 10 to be tailored to the needs of the user and/or the application.

Various heat treating processes can be used to shrink the elongation yarns 14. For example, a continuous oven may be used in an in-line, continuous heating process. The webbing 10 may be continuously woven and fed into the continuous oven for heat treatment. Another example of heat treatment is a batch process in which individual webbings are heat treated.

In one embodiment, a webbing 10 is designed to stop a falling person within 3.5 feet, which is in compliance with 29 C.F.R. 1926.104(d) (2008). In this embodiment, the webbing 10 has a finished, ready-for-use length of about 6 feet. Prior to the heat treatment, the elongation yarns 14 and the ground yarns have a length of approximately 9.5 feet. After heat treatment, the elongation yarns 14 have a reduced length of about 6 feet and the ground yarns 16 essentially retains their length of 9.5 feet. During use of the webbing 10, the elongation yarns 14 will stretch from about 6 feet to about 9.5 feet. When the webbing 10 reaches the maximum 9.5 feet length, the webbing 10 stops the person's fall. The elongation yarns 14 absorb the energy of the fall and reduce the abrupt shock to the person when the webbing 10 stops the fall. In other embodiments, the webbing has a finished, ready-to-use length of about 4 feet. In one embodiment having a ready-to-use length of about 4 feet, the percentage of elongation yarns to ground yarns is approximately the same, however, the ratio of ground yarns to elongation yarns may vary depending on the application. For example, more ground yarns to elongation yarns may be required for higher strength applications, and more elongation yarns to ground yarns may be required when a greater deployment force is required.

In another embodiment of the present invention, a webbing has lengths of the elongation yarns and the ground yarns to stop a falling person within about 11.75 feet. The webbings, however, can be made in any desired length according to the present invention.

The webbings of the present invention can be made of any suitable materials including, but not limited to, synthetic material yarns woven to form the fabric structure.

Various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

1. A method of heat treating a webbing, the webbing comprising a plurality of elongation yarns and a plurality of ground yarns, comprising:
(i) feeding the webbing through a first set of rollers at a roll-in speed;
(ii) heat treating the webbing to adjust the relative lengths of the plurality of elongation yarns and the plurality of ground yarns; and
(iii) feeding the webbing through a second set of rollers at a roll-out speed,
wherein the roll-in speed is different from the roll-out speed.

2. The method of claim 1, wherein the roll-in speed is greater than the roll-out speed.

3. The method of claim 1, further comprising providing the webbing, wherein the plurality of elongation yarns of the webbing are partially oriented yarns.

4. The method of claim 1, wherein the roll-in speed is up to approximately 65% greater than the roll-out speed.

5. The method of claim 2, wherein the roll-in speed is approximately 10 yards per minute and the roll-out speed is approximately 8 yards per minute.

6. The method of claim 1, further comprising cutting the webbing to a predetermined length and then positioning the webbing within a retractor.

7. A webbing comprising:
a plurality of elongation yarns having a reduced length that is less than an original length of the plurality of elongation yarns, wherein the plurality of elongation yarns comprise partially oriented yarns; and
a plurality of ground yarns having a length that is approximately the length of the original length of the plurality of elongation yarns;
wherein the webbing has a length that is approximately equal to the reduced length of the plurality of elongation yarns; and
wherein a weave-in of the plurality of ground yarns is greater than a weave-in of the plurality of elongation yarns.

8. The webbing of claim 7, wherein the webbing is generally flat.

9. The webbing of claim 7, wherein the webbing was processed via heat treatment.

10. The webbing of claim 9, wherein the weave-in of the plurality of the ground yarns and the weave-in of the plurality of the elongation yarns is substantially the same before the heat treatment.

11. The webbing of claim 9, wherein the weave-in of the plurality of the elongation yarns does not change substantially after the heat treatment.

12. The webbing of claim 9, wherein the weave-in of the plurality of ground yarns after the heat treatment is controlled by varying the duration of heat applied to the webbing.

13. The webbing of claim 9, wherein the weave-in of the plurality of ground yarns after the heat treatment is controlled by varying the speeds at which the webbing enters and exits the heat application.

14. The webbing of claim 7, wherein the plurality of elongation yarns extend throughout the webbing in a substantially warp direction, wherein the plurality of ground yarns extend throughout the webbing in a substantially warp direction, and further comprising a plurality of lateral yarns that extend in a substantially weft direction throughout the webbing.

15. The webbing of claim 7, wherein the webbing is capable of being used with a retractor.

16. The webbing of claim 7, wherein the plurality of elongation yarns and the plurality of ground yarns are interwoven together throughout the webbing in a warp direction.

17. A method of manufacturing an energy absorbing webbing, comprising:
(i) providing a plurality of partially oriented yarns comprising an elongation distance;
(ii) providing a plurality of ground yarns;
(iii) interweaving the plurality of ground yarns and the plurality of partially oriented yarns in a warp direction along the webbing;
(iv) providing a plurality of lateral yarns in a weft direction along the webbing;
(v) feeding the webbing through a first set of rollers at a roll-in speed;
(vi) applying heat to the webbing as it is fed between the first set of rollers and a second set of rollers to adjust relative lengths of the plurality of elongation yarns and the plurality of ground yarns; and
(vii) feeding the webbing through the second set of rollers at a roll-out speed,
wherein the roll-in speed is different from the roll-out speed.

18. The method of claim 17, wherein the roll-in speed is up to approximately 65% greater than the roll-out speed.

19. The method of claim 18, wherein the roll-in speed is approximately 10 yards per minute and the roll-out speed is approximately 8 yards per minute.

20. The method of claim 18, further comprising positioning the webbing within a retractor.

21. The method of claim 18, further comprising controlling the elongation distance of the partially oriented yarns by adjusting the roll-in speed relative to the roll-out speed.
